(19) United States
(12) Patent Application Publication
(10) Pub. No.: US 2009/0246617 A1
(43) Pub. Date: Oct. 1, 2009

(54) VANADIUM CONNECTOR IN AN ELECTROCHEMICAL CELL FOR AN IMPLANTABLE MEDICAL DEVICE

(76) Inventors: William G. Howard, Roseville, MN (US); Robert E. Kraska, Minneapolis, MN (US); Hailiang Zhao, Maple Grove, MN (US); Bruce T. Anderson, Minneapolis, MN (US)

Correspondence Address: MEDTRONIC, INC., 710 MEDTRONIC PARKWAY NE, MINNEAPOLIS, MN, 55432-9924, US

(21) Appl. No.: 12/058,092

(22) Filed: Mar. 28, 2008

(51) Int. Cl. H01M 2/26; H01M 4/00; H01M 2/04; B05D 5/12

(52) U.S. Cl. 429/161; 429/211; 429/175; 429/209; 427/58

(57) ABSTRACT

One embodiment of an electrochemical cell for an implantable medical device is presented. The electrochemical cell includes a first electrode. The first electrode includes at least one current collector with a tab extending therefrom. The at least one tab comprises one of vanadium and vanadium alloy.

### TECHNICAL FIELD

The disclosure generally relates to an electrochemical cell for an implantable medical device, and, more particularly, to a vanadium tab that extends from at least one current collector in an electrochemical cell.

### BACKGROUND

Implantable medical devices (IMDs) detect and deliver therapy for a variety of medical conditions in patients. The human anatomy includes many types of tissues that can either voluntarily or involuntarily, perform certain functions. After disease, injury, or natural defect, certain tissues may no longer operate within general anatomical norms. For example, after disease, injury, time, or combinations thereof, the heart muscle may begin to experience certain failures or deficiencies. Certain failures or deficiencies can be corrected or treated with implantable medical devices (IMDs), such as implantable pacemakers, implantable cardioverter defibrillator (ICD) devices, cardiac resynchronization therapy defibrillator devices, implantable pulse generators (IPGs), neurological stimulation devices, drug administering devices, diagnostic recorders, cochlear implants, and the like.

ICDs typically comprise, inter alia, a control module, a capacitor, and a battery that are housed in a hermetically sealed container with a lead extending therefrom. When therapy is required by a patient, the control module signals the battery to charge the capacitor, which in turn discharges electrical stimuli to tissue of a patient. The battery includes a case, a liner, an electrode assembly, and electrolyte. The liner insulates the electrode assembly from the case. The electrode assembly includes electrodes, an anode (also referred to as a negative electrode) and a cathode (also referred to as a positive electrode), with a separator therebetween. For a flat plate battery, an anode comprises a set of anode electrode plates with a set of tabs extending therefrom. The set of tabs are electrically connected through a connector such as a weld or a jumper pin. Each anode electrode plate includes a current collector with anode material disposed thereon. A cathode is similarly constructed. It is desirable to continue to develop new batteries for IMDs.

### BRIEF DESCRIPTION OF THE DRAWINGS

The present invention will become more fully understood from the detailed description and the accompanying drawings, wherein:

FIG. 1 is a cutaway perspective view of an implantable medical device (IMD);

FIG. 2 is a cutaway perspective view of a primary battery or cell in the IMD of FIG. 1;

FIG. 3A is an enlarged view of a portion of an electrode assembly depicted in FIG. 2;

FIG. 3B is a cross-sectional view of a portion of an electrode assembly depicted in FIG. 2;

FIG. 4A is an angled cross-sectional view of a current collector in an electrode plate of the electrode assembly depicted in FIG. 3A;

FIG. 4B is an angled cross-sectional view of the electrode plate that includes the current collector depicted in FIG. 4A along with electrode material disposed thereon; and

FIG. 5 is a top front view of a current collector;

FIG. 6 is a perspective view of a flattened coiled prismatic battery;

FIG. 7 is an exploded view of the flattened coiled prismatic battery depicted in FIG. 6;

FIG. 8 is a schematic view of a member to connect a current collector to the case or cover of a battery;

FIG. 9A is a schematic view of a member that couples a current collector of an electrode to a case or a cover;

FIG. 9B is a schematic view of a member that couples a current collector of an electrode to a case or a cover;

FIG. 9C is a schematic view of a member coupled to a feedthrough pin that extends through the battery case or cover; and

FIG. 10 is a flow diagram for forming an electrochemical cell with a vanadium connector.

### DETAILED DESCRIPTION

The following description of embodiments is merely exemplary in nature and is in no way intended to limit the invention, its application, or uses. For purposes of clarity, the same reference numbers are used in the drawings to identify similar elements.

The present invention is directed to an electrochemical cell such as a battery or a capacitor for an implantable medical device (IMD). One embodiment of the battery, for example, includes electrodes, an anode and a cathode, with a separator therebetween. An electrode includes at least one current collector and/or a tab that comprises vanadium (V) a V alloy, or cladded V. Exemplary V alloys include V-4 chromium (Cr)-4 titanium (Ti) and V-15Cr-5Ti wherein the numerical values are in weight percentages.

A vanadium tab and/or a vanadium current collector in a primary and/or secondary cell or battery helps to minimize adverse affects on magnetic resonance imaging (MRI) associated with medical devices. For example, vanadium does not interfere or exhibits minimal interference with the formation of the MRI image. Moreover, vanadium substantially reduces or eliminates heating of, for example, the battery during the MRI. Additionally, vanadium exhibits a substantially lower corrosion rate (i.e. 70 micro-inches per year) under cell operating conditions compared to conventional materials. Vanadium also exhibits excellent ability to be welded with dissimilar metals compared to conventional tab and/or current collector materials. Vanadium also enhances the reliability of the connection between the battery electrode and the case or the battery electrode and the feedthrough pin.

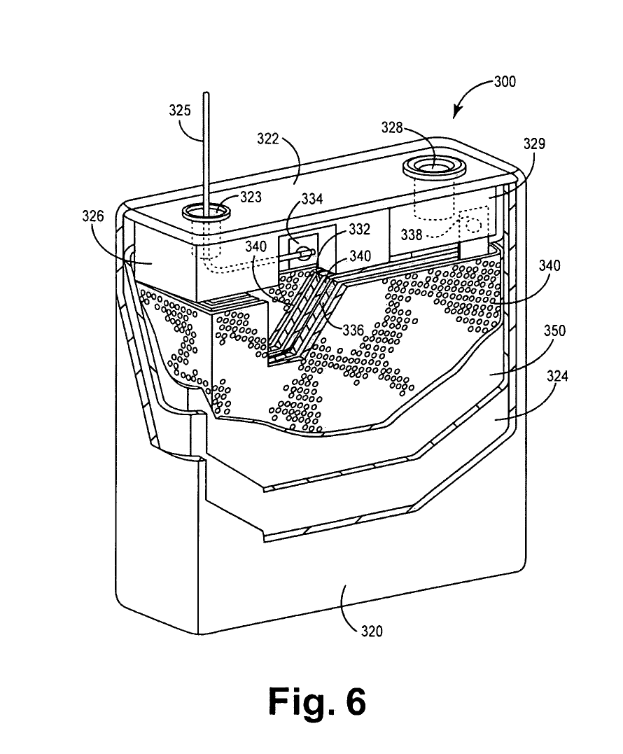

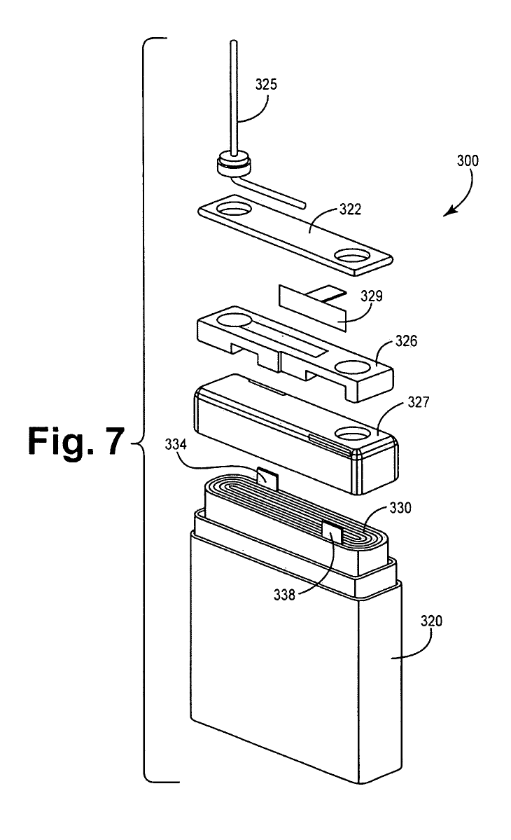

Principles of the claimed invention apply to a primary cell and/or a secondary cell (also referred to as primary battery or secondary battery). The primary or secondary cells can be configured in a variety of ways. Primary or secondary cells can be configured in a “jelly roll,” such as that which is presented and described relative to FIGS. 6-7. Furthermore, the claimed invention applies to high rate batteries (i.e. greater than 1.0 ampere current capability), medium rate batteries (i.e. 10⁻¹ to 10⁻³ amperes of current capability), or low rate batteries (i.e. 10⁻⁴ to 10⁻⁶ amperes current capability).

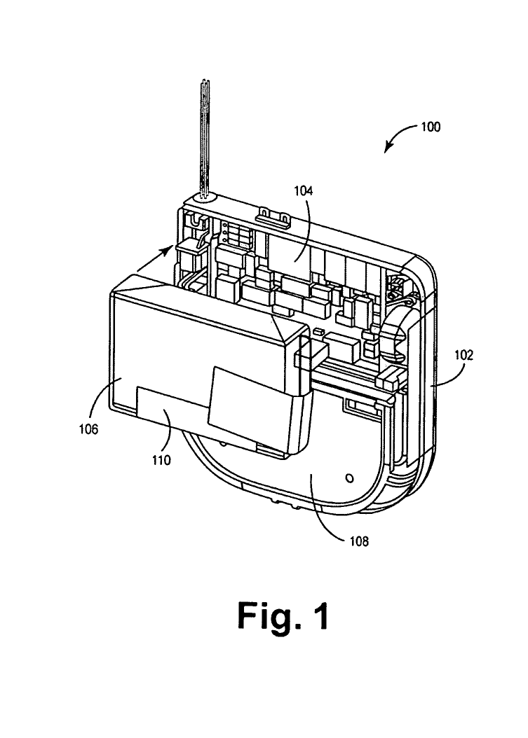

FIG. 1 depicts an IMD 100. IMD 100 includes implantable pacemakers, implantable cardioverter defibrillator (ICD) devices, cardiac resynchronization therapy defibrillator devices, implantable pulse generators (IPGs), neurological stimulation devices, drug administering devices, diagnostic recorders, cochlear implants, and the like. Exemplary IMDs are commercially available as including one generally known to those skilled in the art, such as the Medtronic CONCERTO™, SENSIA™, VIRTUOSO™, RESTORE™, RESTORE ULTRA™, sold by Medtronic, Inc. of Minnesota. Non-implantable medical devices or other types of devices may also utilize batteries such as external drug pumps, hearing aids and patient monitoring devices or other suitable devices.

IMD 100 includes a case 102, a control module 104, a battery 106 (e.g. organic electrolyte battery etc.) and capacitor(s) 108. Case 102 comprises a conductive material such as titanium, titanium alloy, stainless steel, or other suitable material. Control module 104 controls one or more sensing and/or stimulation processes from IMD 100 via leads (not shown). “Module” refers to an application specific integrated circuit (ASIC), an electronic circuit, a processor (shared, dedicated, or group) and memory that execute one or more software or firmware programs, a combinational logic circuit, or other suitable components that provide the described functionality.

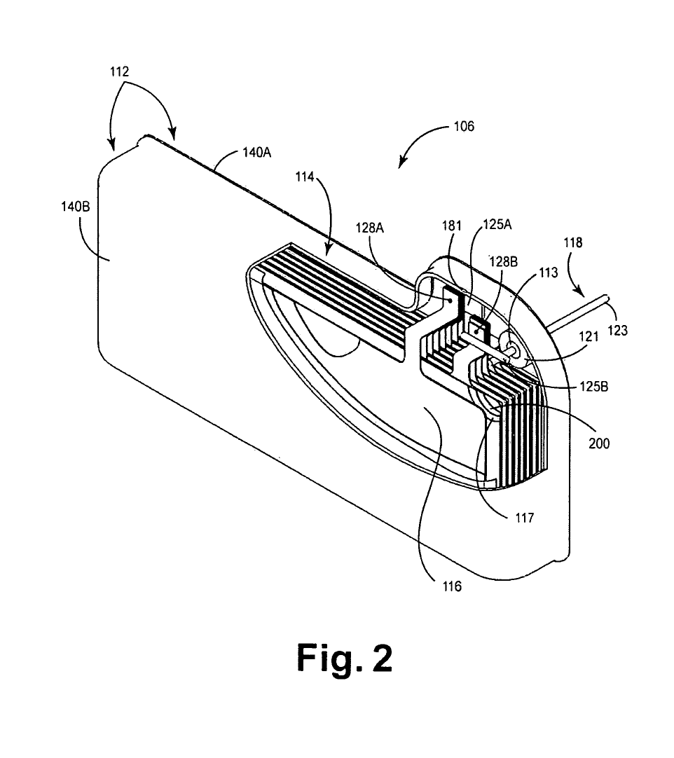

Battery 106 includes an insulator 110 (or liner) disposed therearound. Battery 106 charges capacitor(s) 108 and powers control module 104. FIGS. 2 through 5 depict details of an exemplary primary battery 106 or primary cell used in IMD 100. Battery 106 includes an encasement 112 or housing, a feed-through terminal 118, a fill port 181 (partially shown) or aperture, a liquid electrolyte 116, and an electrode assembly 114. Encasement 112, formed by a cover 140A and a case 140B, houses electrode assembly 114 with electrolyte 116. Fill port 181 (partially shown) or an aperture allows introduction of liquid electrolyte 116 to electrode assembly 114. Electrolyte 116 creates an ionic path between anode 115 and cathode 119 of electrode assembly 114. Electrolyte 116 serves as a medium for migration of ions between anode 115 and cathode 119 during an electrochemical reaction with these electrodes. Exemplary electrolyte 116 includes lithium tetrafluorborate (LiBF₄) in gamma-butyrolactone/dimethoxyethane, lithium hexafluoroarsenate (LiAsF₆) in propylene carbonate/dimethoxyethane or other suitable compounds.

Feed-through assembly 118, formed by pin 123, insulator member 113, and ferrule 121, is electrically connected to jumper pin 125B through a weld formed through a set of tabs 128B. Jumper pin 125B may comprise a conductive material such as vanadium, aluminum, nickel, niobium, vanadium alloys. Vanadium can be alloyed with one or more elements to the extent that the V alloy remains a substitutional solid solution, i.e., is free of intermetallic phases. Exemplary V alloys include V-4 chromium (Cr)₄ titanium (Ti) and V-15Cr-5Ti wherein the numerical values are in weight percentages. Vanadium can also be cladded with other refractory or non-refractory-type materials. Exemplary refractory materials include chromium, titanium, molybdenum, niobium or columbium, tantalum, tungsten, halfnium and zirconium. Exemplary non-refractory materials include aluminum (Al) 300 series stainless steels or other like material. Vanadium cannot be clad to pure Cr due to Cr being very brittle. Vanadium can be cladded by bonding a vanadium sheet with other metal sheet to form a layered structure. Exemplary cladding processes include cold and/or hot rolling or explosive bonding. The connection between pin 123 and jumper pin 125B allows delivery of positive charge from electrode assembly 114 to electronic components outside of battery 106.

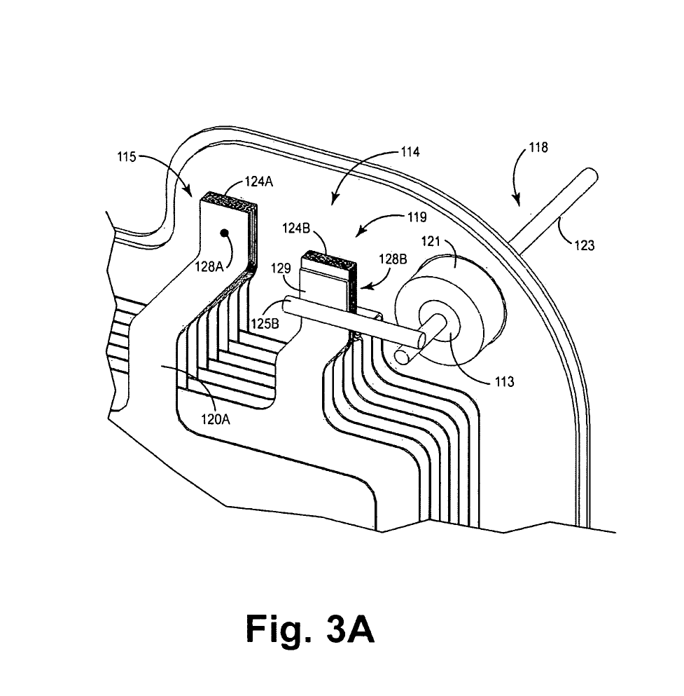

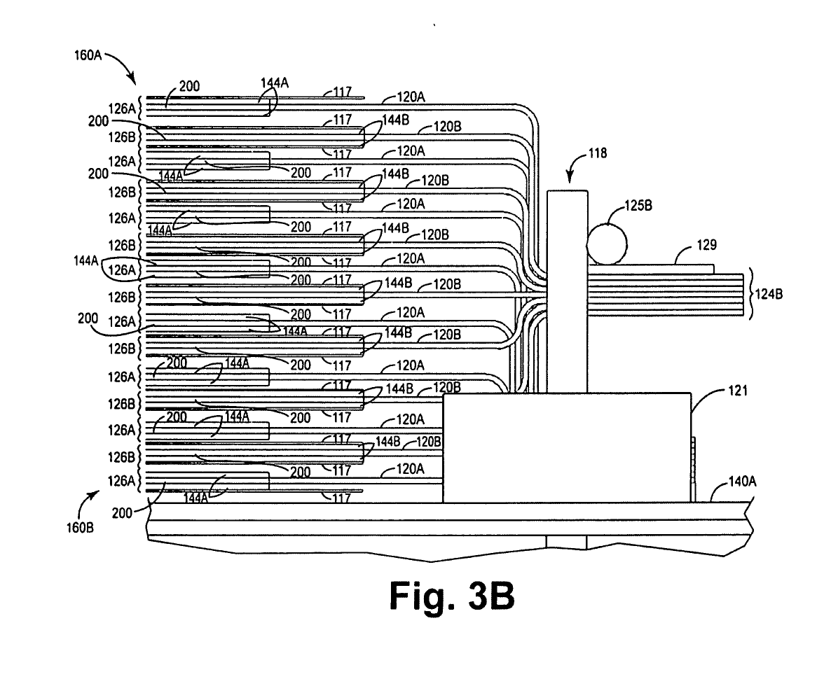

Referring to FIGS. 3A-3B, electrode assembly 114 is depicted as a stacked assembly. Anode 115, which is an electrode through which electric current flows into, comprises a set of electrode plates 126A (i.e. anode electrode plates) with a set of tabs 124A that are conductively coupled via a conductive coupler 128A (also referred to as an anode collector). Conductive coupler 128A can be a weld or a separate coupling member. Optionally, conductive coupler 128A is connected to an anode interconnect jumper 125A (also referred to as the jumper connector or connector), as shown in FIG. 2.

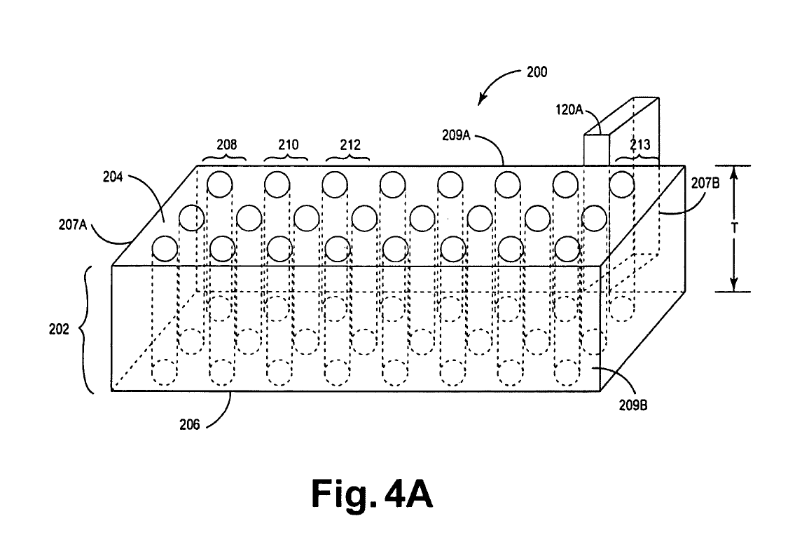

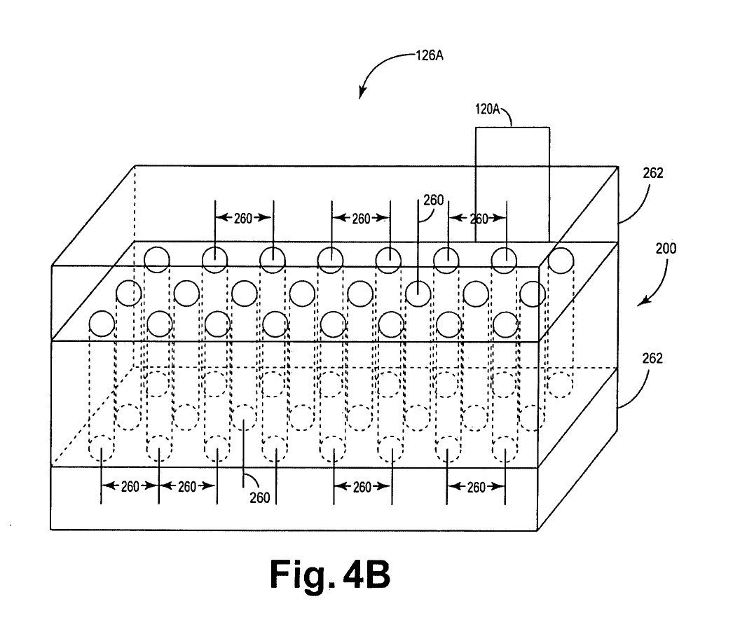

Each electrode plate 126A includes a current collector 200 or grid, a tab 120A extending therefrom, and electrode material 144A. Referring to FIG. 4B, tab 120A comprises conductive material such as vanadium, a vanadium alloy or vanadium cladded with other metals. The vanadium can be alloyed or cladded with one or more refractory type materials such as chromium, titanium, molybdenum, niobium (columbium), tantalum, tungsten, halfnium and zirconium. The vanadium alloys can be configured so as to retain a substitutional solid solution that is free of intermetallic compounds. Tab 120A can have a thickness that ranges from about 10 micrometer (μm) to about 250 μm. Electrode material 144A includes elements from Group IA, IIA or IIIB of the periodic table of elements (e.g. lithium, sodium, potassium, etc.), alloys thereof, intermetallic compounds (e.g. Li—Si, Li—B, Li—Si—B etc.), or an alkali metal (e.g. lithium, etc.) in metallic form. As shown in FIG. 3B, a separator 117 is coupled to electrode material 144A at the top and bottom 160A-B electrode plates 126A, respectively. Separator 117 typically comprises a microporous polypropylene membrane such as Celgard 2500 commercially available from Celgard located in Charlotte, N.C.

Cathode 119 is constructed in a similar manner as anode 115. Cathode 119, which is an electrode in which electric current flows out, includes a set of electrode plates 126B (i.e. cathode electrode plates), a set of tabs 124B, and a conductive coupler 128B connecting set of tabs 124B. Conductive coupler 128B or cathode collector is connected to conductive member 129 and jumper pin 125B (also referred to as the jumper connector or connector). Conductive member 129, shaped as a plate, comprises titanium, aluminum/titanium clad metal or other suitable materials. Jumper pin 125B is also connected to feed-through assembly 118, which allows cathode 119 to deliver positive charge to electronic components outside of battery 106. Separator 117 is coupled to each cathode electrode plate 126B.

Each cathode electrode plate 126B includes a current collector 200 or grid, electrode material 144B and a tab 120B extending therefrom. Tab 120B comprises electrically conductive material such as vanadium or vanadium alloy. Vanadium can be alloyed or cladded with other refractory type materials such as chromium, titanium, molybdenum, niobium or columbium, tantalum, tungsten, halfnium and zirconium. Electrode material 144B or cathode material includes metal oxides (e.g. vanadium oxide, silver vanadium oxide (SVO), manganese dioxide (MnO₂) etc.), carbon monofluoride and hybrids thereof (e.g., CFₓ+MnO₂), combination silver vanadium oxide (CSVO), lithium ion, other rechargeable chemistries, or other suitable compounds.

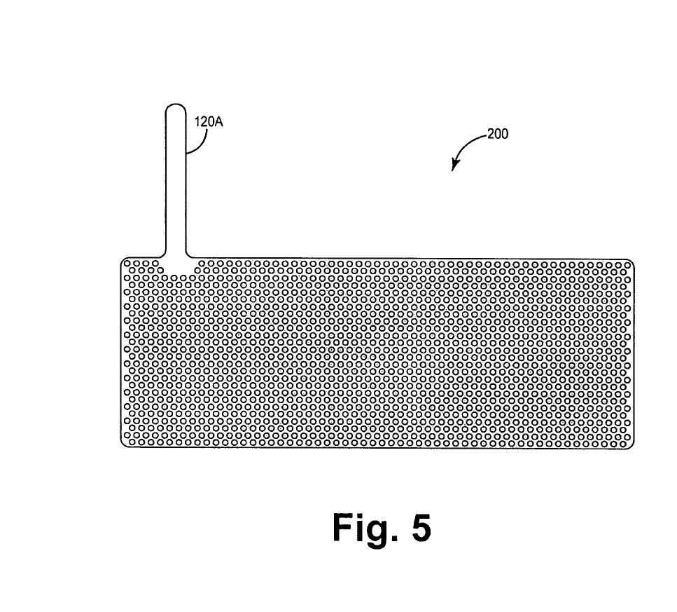

FIGS. 4A-4B and 5 depict details of current collector 200. Current collector 200 is a conductive layer 202 that includes sides 207A, 207B, 209A, 209B, a first surface 204 and a second surface 206 with a tab 120A protruding therefrom. A first, second, third, and N set of apertures 208, 210, 212, 213, respectively, extend from first surface 204 through second surface 206. N set of apertures are any whole number of apertures. Conductive layer 202 may comprise a variety of conductive materials. Current collectors 200 for an anode 115 can comprise aluminum, nickel, titanium, copper or other suitable conductive material. Current collectors 202 for cathode 119 and tab 120B may comprise or consist essentially of titanium, aluminum, vanadium or other suitable materials. In one embodiment, vanadium can be used in all sizes of implantable cells such as large, medium or small cells. Large cells have capacities greater than about 2000 milliamperes hour (mah) whereas small cells possess capacities less than about 50 mah. Milliampere hour is the deliverable capacity from the cell. In another embodiment, vanadium is used as a current collector in small cells and not in medium or large cells. Vanadium improves the reliability of the connection and/or provides MRI safe features to the IMD.

FIGS. 6-7 depict a flattened coiled prismatic battery 300 (also referred to as a “jelly roll” battery). Battery 300 encompasses primary batteries, secondary batteries or rechargeable batteries. Exemplary secondary or rechargeable batteries that could implement the claimed invention include RESTORE™ and RESTORE ULTRA™ from Medtronic, Inc. of Minnesota. Battery 300 includes a battery case or housing 320, liner 324, cover 322, head space insulator 326, coil liner 327, member 329 or connector, cell element 330, separator 340, aperture 320, and positive and negative electrode 332, 336, respectively. Case 320 may be made of stainless steel or another metal such as titanium, aluminum, or alloys thereof. Case 320 can also be made of a plastic material or a plastic-foil laminate material (e.g., an aluminum foil provided intermediate a polyolefin layer and a polyester layer).

Liner 324 is adjacent or proximate to the case 320 to separate internal components of the battery 300 from the case 320. Liner 324 can be made of ethylene tetrafluoroethylene (ETFE) and can have a thickness of between about 25 μm and 250 μm.

A cover or cap 322 is provided at a top surface of battery 300 and can be coupled (e.g., welded, adhered, etc.) to case 320. Headspace insulator 326 is provided within case 320 to provide a space in which connections may be made to electrodes provided within case 320. Coil liner 327, as shown in FIG. 7, may be provided which can act to separate a cell element from the headspace region of battery 300.

Battery 300 includes a cell element 302 (FIG. 7) provided within case 320 that comprises at least one positive electrode 322 and at least one negative electrode 336. Positive electrode 332 and/or negative electrode 336 may be provided as flat or planar components and can be wound in a spiral or other configuration, or can be provided in a folded configuration. For example, the electrodes may be wrapped around a relatively rectangular mandrel such that they form an oval wound coil for insertion into a relatively prismatic battery case.

Separator 340 is provided intermediate or between positive electrode 332 and negative electrode 360. Separator 340 is a polymeric material such as a polypropylene/polyethelene copolymer or another polyolefin multilayer laminate that includes micropores formed therein to allow electrolyte and lithium ions to flow from one side of the separator to the other. The thickness of separator 340 is between about 10 μm and about 50 μm with an average pore size of that is between about 0.02 μm and 0.1 μm.

Electrolyte 350 is provided in the case 320 (e.g., through an opening or aperture 328 in the form of a fill port provided in cover 332 of battery 300) to provide a medium through which lithium ions can move. Exemplary electrolyte includes a liquid (e.g., a lithium salt dissolved in one or more non-aqueous solvents), a lithium salt dissolved in a polymeric material such as poly(ethylene oxide) or silicone, an ionic liquid such as N-methyl-N-alkylpyrrolidinium bis(trifluoromethanesulfonyl)imide salts, a solid state electrolyte such as a lithium-ion conducting glass such as lithium phosphorous oxynitride (LiPON) or other suitable materials.

Positive electrode 322 is formed from a metal such as aluminum or an aluminum alloy having a layer of active material (e.g., lithium cobalt oxide (LiCoO₂) provided thereon. Any of a variety of active materials may be utilized for the metal and active material according to various exemplary embodiments as may be now known or later developed. The thickness of the positive electrode 332 is between about 5 μm and 250 μm. In another embodiment, the thickness of the positive electrode 322 is about 75 μm. Positive electrode's 332 current collector may be a thin foil material, or may be a grid such as a mesh grid, an expanded metal grid, a photochemically etched grid, or the like.

Negative electrode 336 is formed from a metal such as copper, a copper alloy or aluminum having a layer of active material (e.g., a carbon material such as graphite) provided thereon. Any of a variety of active materials may be utilized for the metal and active material according to various exemplary embodiments as may be now known or later developed. The thickness of the negative electrode 336 is between about 5 μm and 250 μm. The negative electrode 336 may be a thin foil material, or may be a grid such as a mesh grid, an expanded metal grid, a photochemically etched grid, or the like.

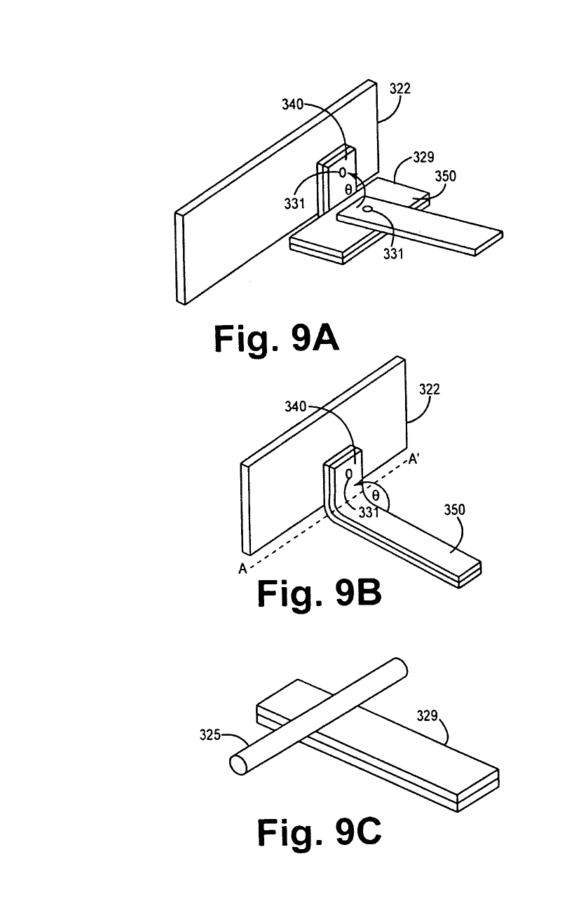

As depicted in FIGS. 6-7, a tab or current conductor 334 is in electrical contact with positive electrode 332. Tab 334 is formed from aluminum or aluminum alloy and has a thickness of between about 0.05 mm and 0.15 mm. Additionally, a tab or current collector 338 is in electrical contact with negative electrode 336. Current collector 334 of positive electrode is electrically coupled to a feedthrough pin or terminal 325 (FIG. 9C) that protrudes through an opening or aperture 323 provided in cover 322. Feedthrough pin or terminal 325 connects the positive electrode 332 to electronic components located outside of battery case 320. Current collector 338 is formed from vanadium, a vanadium alloy or aluminum and has a thickness of between about 0.05 mm and about 0.15 mm.

One embodiment of the invention relates to a member 329 or element that couples a current collector 338 to case 320 or to cover 332. In one embodiment, member 329 comprises vanadium, vanadium alloy, vanadium cladded with another electrically conductive material titanium/vanadium, vanadium/aluminum etc.) In yet another embodiment, member 329 comprises other suitable cladded material such as titanium/aluminum.

In one embodiment, member 329 couples current collector 334 to pin or terminal 325. Vanadium member or element 329, for example, couples a current collector 338 or tab of a negative electrode 336 to cover 322. In one embodiment, member or element 329 is in the form of a bracket or a splice. A bracket is an overhanging member that projects from a structure. Splice is an interconnect or graft that joins or unites two members by welding the over lapping ends together. Referring to FIGS. 6-9B, in one embodiment, a substantially T-shaped member 329 is depicted. Member 329 comprises a first arm 340 integrally formed with a second arm 350. In another embodiment, first arm 340 is coupled to second arm 350, through, for example, a weld or other suitable means. Connecting two or more arms together allows member 329 to form a variety of shapes such as a H-shape, a T-shape or an L-shape. While the L-shape and the T-shape typically comprise two arms (i.e. a first arm and a second arm), the H-shape can be formed of three arms (i.e. first, second and third arms). First arm 340 comprises a first, second, third side 342a, 342b, and 346, respectively. Second arm 350 includes a first, second, and third side 252a, 252b, 354, respectively.

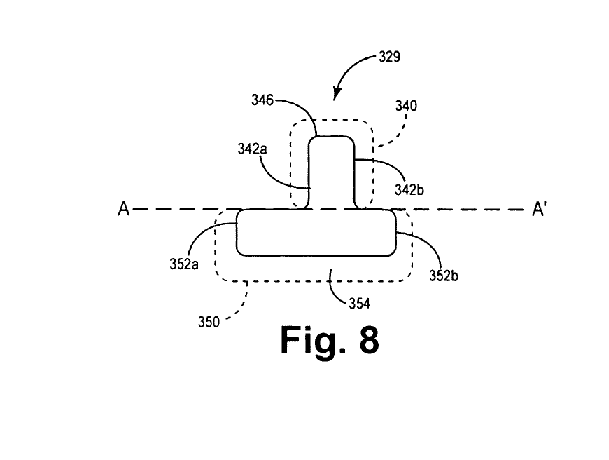

Referring to FIGS. 9A-9B, first and second arms 340, 350 are bent at angle θ (e.g. up to about 90 degrees) or about perpendicular relative to each other along line A-A′ of FIG. 8. Second arm 340 can be welded 331 to cover 322 while first arm 350 overlaps the current collector 338 or tab. After first arm 350 is placed in a position such that first arm 350 overlaps current collector 338, first arm 350 is directly connected to the current collector 338 or tab through a weld 331. As shown in FIG. 8, member or element 329 is depicted as being substantially T-shaped; however, other suitable shapes can also be used such as a L-shape, an H-shape or even be a simple strip of foil, or a pin or a wire. Member 139 is also welded to the cover 322. Cover 322, in turn, is directly connected to case 320, through, for example, a welding operation. In another embodiment, member 139 can coupled to case 320 in place of cover 322. Member 329 comprises V or V alloy, or V—Ti clad metal, or Ti—Al clad metal. Vanadium can be alloyed or clad with other refractory type materials such as chromium, titanium, molybdenum, niobium, columbium, tantalum, tungsten, halfnium and/or zirconium.

Numerous types of batteries may include a vanadium connector such as member 329. For example, vanadium member 329 can be used in a rechargeable battery such as a lithium-ion battery placed in a titanium or titanium alloy (e.g. Ti-6Al-4V, Ti-3Al-2.5V etc.) case 320. The rechargeable battery includes positive and negative electrodes 332, 336 along with a mixture of ethylene carbonate to ethylmethyl carbonate with 1M LiPF₆ electrolyte. In this embodiment, the negative electrode 336 includes active material such as lithium titanate (Li₄Ti₅O₁₂). Current collector 338 comprises aluminum or aluminum alloy with an aluminum or aluminum alloy tab 334. The positive electrode 332 includes lithium cobalt oxide (LiCoO₂). The aluminum tab from the negative electrode tab 338 is connected to the titanium case 320 by a vanadium member 329. In this embodiment, member 329 is welded or connected in some manner to both the aluminum tab 338 and the titanium case 320.

Another exemplary battery involves a case negative primary cell. A primary cell can be incorporated into a neurostimulation device, cardiac device, or other like device. In this embodiment, a lithium primary cell can include a titanium case 320, a lithium metal anode 115, and a cathode 119 along with mixture of propylene carbonate to dimethoxyethane with 1M LiAsF₆ electrolyte. Anode 115 includes one or more vanadium current collectors 200 with a vanadium tab 120 extending from each current collector 200. Cathode 119 consists of silver vanadium oxide disposed over a titanium current collector 200. The vanadium electrode tab 120A is connected to the titanium case by a weld or other suitable means.

Yet another exemplary battery involves a case positive primary cell. In this embodiment, a lithium primary cell can include a titanium case 320, a lithium negative electrode 336, and a positive electrode 332. Negative electrode 336 includes one or more vanadium current collectors 338 or a vanadium tab. Positive electrode 332 consists of silver vanadium oxide disposed over a current collector 334 with a vanadium tab that is connected to the titanium case by a weld or other suitable means.

Yet another exemplary battery involves a case positive rechargeable cell. For example, a lithium-ion cell includes a titanium case 320, a negative electrode 336, and a positive electrode 332 along with 1:1 mixture of ethylenecarbonate to diethylcarbonate with 1M LiPF₆ electrolyte. The 1M LiPF₆ electrolyte can also be used in a case negative design described above. Negative electrode 336 comprises lithium titanate (Li₄Ti₅O₁₂) whereas positive electrode 332 comprises lithium cobalt oxide (LiCoO₂). The positive electrode 332 includes an aluminum current collector with an aluminum tab 334. The aluminum positive electrode tab 334 is connected to the titanium case 320 by a vanadium member 339, which is welded to both the aluminum tab 334 and titanium case 320.

Still yet another battery involves a case negative rechargeable cell. A case negative rechargeable cell has a case with the same polarity as the negative electrode. A lithium-ion cell utilizes a stainless steel case 320, a negative electrode 336, and a positive electrode 332 along with 1:1 mixture of ethylenecarbonate to dimethylcarbonate with 1M LiPF₆ electrolyte. Negative electrode 336 comprises a carbon lithium intercalation compound (e.g. C₆Li) with a copper current collector 338 and a vanadium tab that extends therefrom. A positive electrode 332 includes a mixture of lithium cobalt oxide (LiCoO₂) and lithium manganese oxide (LiMnO₄). The vanadium negative electrode tab 336 is connected to the stainless steel case 322 (e.g. 300 series austenitic stainless steel class) by a vanadium member 329 which is welded to both the vanadium tab 338 and a stainless steel case 322.

Still yet another battery may involve a case positive rechargeable cell. A case positive rechargeable cell has a case that possesses the same polarity as the positive electrode. In this embodiment, the lithium-ion cell utilizes an aluminum or aluminum alloy case 320. The battery includes a negative electrode 336 that comprises carbon (C₆Li) with a copper or aluminum current collector with a vanadium tab 338, a positive electrode 332 consisting of lithium cobalt oxide (LiCoO₂) with an aluminum current collector with an aluminum tab. The negative electrode vanadium tab is connected to the titanium alloy feedthrough pin.

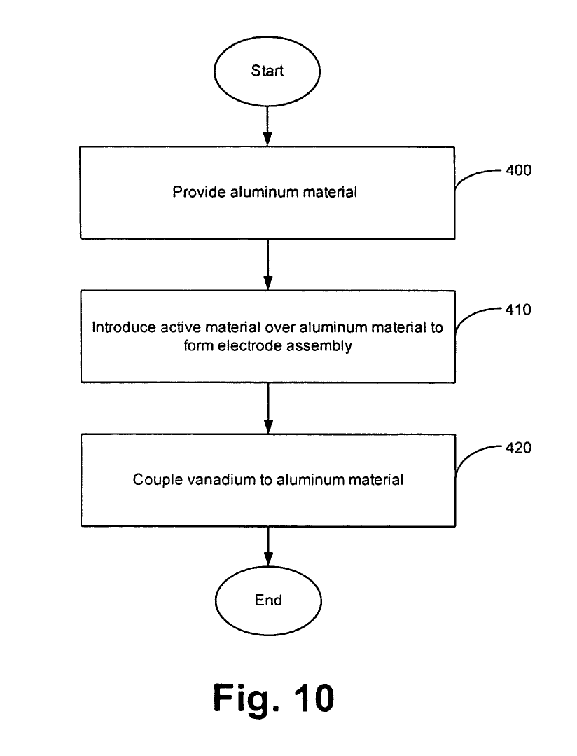

FIG. 10 depicts a flow diagram for forming an electrochemical cell such as a battery that includes a vanadium connector. At block 400, an aluminum material is provided. For example, a piece of aluminum foil is provided or placed onto a surface. At block 410, active material such as anodic or cathodic material is introduced over the aluminum material to form an electrode assembly. At block 420, a vanadium or vanadium alloy tab is connected or coupled to the aluminum material of the electrode assembly. Thereafter, the electrode assembly is punched or cut to a predetermined size. The predetermined size is based upon the capacity, power and cell balance requirements.

Skilled artisans appreciate that alternative embodiments can be implemented using the principles described herein. For example, member 329 can be in the form of a wire. Various other electrolytes may be used according to other exemplary embodiments. For example, according to an exemplary embodiment, the electrolyte may be a 1:1 mixture of ethylene carbonate to diethylene carbonate (EC:DEC) in a 1.0 Molar (M) salt of LiPF₆. The electrolyte may include a polypropylene carbonate solvent and a lithium bis-oxalatoborate salt (sometimes referred to as LiBOB). For example, the claimed invention can be implemented utilizing various electrolytes in secondary or rechargeable cells. Other exemplary electrolyte may comprise one or more of a PVDF copolymer, a PVDF-polyimide material, and organosilicon polymer, a thermal polymerization gel, a radiation cured acrylate, a particulate with polymer gel, an inorganic gel polymer electrolyte, an inorganic gel-polymer electrolyte, a PVDF gel, polyethylene oxide (PEO), a glass ceramic electrolyte, phosphate glasses, lithium conducting glasses, lithium conducting ceramics, and an inorganic ionic liquid or gel, among others.

The description of the invention is merely exemplary in nature and, thus, variations that do not depart from the gist of the invention are intended to be within the scope of the invention. Such variations are not to be regarded as a departure from the spirit and scope of the invention. For example, while several embodiments include specific dimensions, skilled artisans appreciate that these values will change depending, for example, on the shape of a particular element.

1. An electrochemical cell in an implantable medical device (IMD) comprising:
a first electrode that includes at least one current collector with a tab extending therefrom, the at least one tab comprises one of vanadium, vanadium alloy, and vanadium clad material.

2. The electrochemical cell of claim 1, further comprising:
a second electrode that includes at least one current collector with a tab or a wire extending therefrom, the at least one tab comprises one of vanadium and vanadium alloy, and vanadium clad with one of a refractory material and a non-refractory material.

3. The electrochemical cell of claim 2, wherein the refractory material comprises at least one of chromium, titanium, molybdenum, niobium, tantalum, tungsten, halfnium and zirconium.

4. The electrochemical cell of claim 1 wherein the tab possess one of a substantially T-shape, a H-shape and an L-shape.

5. The electrochemical cell of claim 1 wherein the tab includes a first arm integrally formed to a second arm.

6. The electrochemical cell of claim 1 wherein the tab includes a first arm coupled to a second arm.

7. The electrochemical cell of claim 5 wherein the first arm is about perpendicular to the second arm.

8. The electrochemical cell of claim 5 further comprising:
a cover for the electrochemical cell, the cover coupled to the first arm.

9. An electrochemical cell in an IMD comprising:
a first electrode that includes at least one current collector, and
a member that comprises one of vanadium and vanadium alloy, the member couples the current collector to a case for the electrochemical cell.

10. The electrochemical cell of claim 9, wherein the first electrode consists of a negative electrode.

11. The electrochemical cell of claim 9, wherein the first electrode consists of a positive electrode.

12. An electrode for an electrochemical cell in an IMD comprising:
a plurality of electrode plates, wherein each electrode plate includes a tab extending therefrom, at least one of the tabs from a set of tabs comprises one of vanadium and a vanadium alloy.

13. The electrode of claim 12 wherein the set of tabs connected through one of a weld and a connector.

14. The electrode of claim 12 wherein the connector comprises one of vanadium and vanadium alloy.

15. A battery for an IMD comprising:
an anode that includes at least one current collector with a tab extending therefrom, the at least one tab comprises one of vanadium and vanadium alloy; and
a cathode that includes at least one current collector with a tab extending therefrom, the at least one tab comprises one of vanadium and vanadium alloy.

16. A battery for an IMD comprising:
an anode that includes a first electrode plate that includes a current collector with a tab extending therefrom, the at least one tab comprises one of vanadium and vanadium alloy; and
a cathode that includes a second electrode plate that includes a current collector with a tab extending therefrom, the at least one tab comprises one of vanadium and vanadium alloy.

17. A method of forming an electrode for an electrochemical cell in an IMD comprising:
providing a first electrode that includes at least one current collector with a tab extending therefrom, the tab comprises one of vanadium and vanadium alloy.

18. A method of forming an electrode for an electrochemical cell in an IMD comprising:
providing an aluminum material;
introducing active material over the aluminum material to form an electrode assembly; and
coupling a vanadium or vanadium alloy tab to the aluminum material.

19. The method of claim 18 further comprising:
punching the electrode assembly to a predetermined size.

20. An electrochemical cell in an IMD comprising:
a first electrode that includes at least one current collector with a tab extending therefrom, the at least one tab comprises clad material.

21. The electrochemical cell of claim 20 wherein the clad material comprises one of titanium/aluminum, titanium/vanadium, vanadium/aluminum.
